(19) United States
(12) Patent Application Publication
(10) Pub. No.: US 2012/0120967 A1
(43) Pub. Date: May 17, 2012

(54) Universal Serial Interface

(76) Inventors: Ali Ghiasi, Cupertino, CA (US); Krishna Kalidindi, San Jose, CA (US); David Berry, San Jose, CA (US)

(21) Appl. No.: 13/077,521

(22) Filed: Mar. 31, 2011

Related U.S. Application Data
(60) Provisional application No. 61/412,894, filed on Nov. 12, 2010.

(51) Int. Cl. H04J 99/00; G06F 15/16

(52) U.S. Cl. 370/464; 709/204

(57) ABSTRACT

A communication device may utilize a serial interface to communicate with a peer device via a serial interface link utilizing a serial interface protocol. The communication device may be operable to generate a first serial signal from a first plurality of signals associated with one or more interface protocols. The generated first serial signal may be communicated to the peer device via the serial interface link. The peer device may then regenerate the first plurality of signals from the communicated first serial signal. The communication device may be operable to receive a second serial signal from the peer device via the serial interface link. The second serial signal was generated by the peer device from a second plurality of signals associated with the one or more interface protocols. The communication device may then regenerate the second plurality of signals from the received second serial signal.

### CROSS-REFERENCE TO RELATED APPLICATIONS/INCORPORATION BY REFERENCE

This patent application makes reference to, claims priority to, and claims benefit from U.S. Provisional Application Ser. No. 61/412,894, which was filed on Nov. 12, 2010.

The above stated application is hereby incorporated herein by reference in its entirety.

### FIELD OF THE INVENTION

Certain embodiments of the invention relate to communication systems. More specifically, certain embodiments of the invention relate to a method and system for a universal serial interface.

### BACKGROUND OF THE INVENTION

PCs, laptops and TVs offer several interfaces. The PCs or laptops may offer, for example, high definition multimedia interface (HDMI) for connection to TVs, digital visual interface (DVI) and/or display port (DP) for connection to monitors, universal serial bus (USB) for connection to peripheral devices, Ethernet ports for connection to networks, and/or card reader for reading flash devices. The TVs may offer, for example, HDMI for high definition (HD) content, RF ports, Ethernet ports and/or legacy interfaces. Adding so many interfaces on the PCs, laptops and/or TVs consumes significant amount of face plate, does not scale to smaller devices such as tablet, is not scalable, creates significant amount of cable cluttering, and is expensive.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for a universal serial interface, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary communication system that is operable to provide a universal serial interface, in accordance with an embodiment of the invention.

FIG. 2 is a block diagram illustrating an exemplary universal serial interface module that is operable to provide a universal serial interface in a communication device, in accordance with an embodiment of the invention.

FIG. 3 is a block diagram illustrating an exemplary universal serial interface module that is operable to provide a universal serial interface in a peer device, in accordance with an embodiment of the invention.

FIG. 4 is a block diagram illustrating an exemplary signal frame transported by a serial interface link, in accordance with an embodiment of the invention.

FIG. 5 is a flow chart illustrating exemplary steps for a universal serial interface, in accordance with an embodiment of the invention.

FIG. 6 is a flow chart illustrating exemplary steps for implementing a universal serial interface, in accordance with an embodiment of the invention.

### DETAILED DESCRIPTION OF THE INVENTION

Certain embodiments of the invention can be found in a method and system for a universal serial interface. In various embodiments of the invention, a communication device, which comprises a serial interface and is operable to utilize the serial interface to communicate with a peer device via a serial interface link utilizing a serial interface protocol, may be operable to generate a first serial signal from a first plurality of signals associated with one or more interface protocols. The generated first serial signal may be communicated to the peer device via the serial interface link utilizing the serial interface protocol. In this regard, the peer device may be operable to regenerate the first plurality of signals from the communicated first serial signal. The communication device may be operable to receive a second serial signal from the peer device via the serial interface link utilizing the serial interface protocol. The second serial signal was generated by the peer device from a second plurality of signals associated with the one or more interface protocols. In this regard, the communication device may be operable to regenerate the second plurality of signals from the received second serial signal.

In an exemplary embodiment of the invention, one of the first plurality of signals may comprise a first management signal associated with a management interface protocol, and one of the second plurality of signals may comprise a second management signal associated with the management interface protocol. In such instances, the communication device may be operable to configure the serial interface link based on a bandwidth requirement associated with each of the first plurality of signals and a link speed associated with the serial interface link utilizing the first management signal and/or the second management signal. The first plurality of signals may be multiplexed into the first serial signal by the communication device, based on the configuration, and the first serial signal may be communicated to the peer device via the configured serial interface link. In this regard, the peer device may be operable to de-multiplex the communicated first serial signal into the first plurality of signals.

The peer device may be operable to configure the serial interface link based on a bandwidth requirement associated with each of the second plurality of signals and a link speed associated with the serial interface link utilizing the first management signal and/or the second management signal. In this regard, the second plurality of signals may be multiplexed by the peer device into the second serial signal, based on the configuration. The communication device may be operable to receive the second serial signal from the peer device via the configured serial interface link and de-multiplex the received second serial signal into the second plurality of signals.

In some instances, the serial interface link may comprise an interface using a copper medium, for example. In other instances, the serial interface link may comprise an interface using an optical cable, for example. The serial interface protocol may comprise, for example, a 64B/66B coding and/or a bit error rate (BER) reduction utilizing an error correction code (ECC).

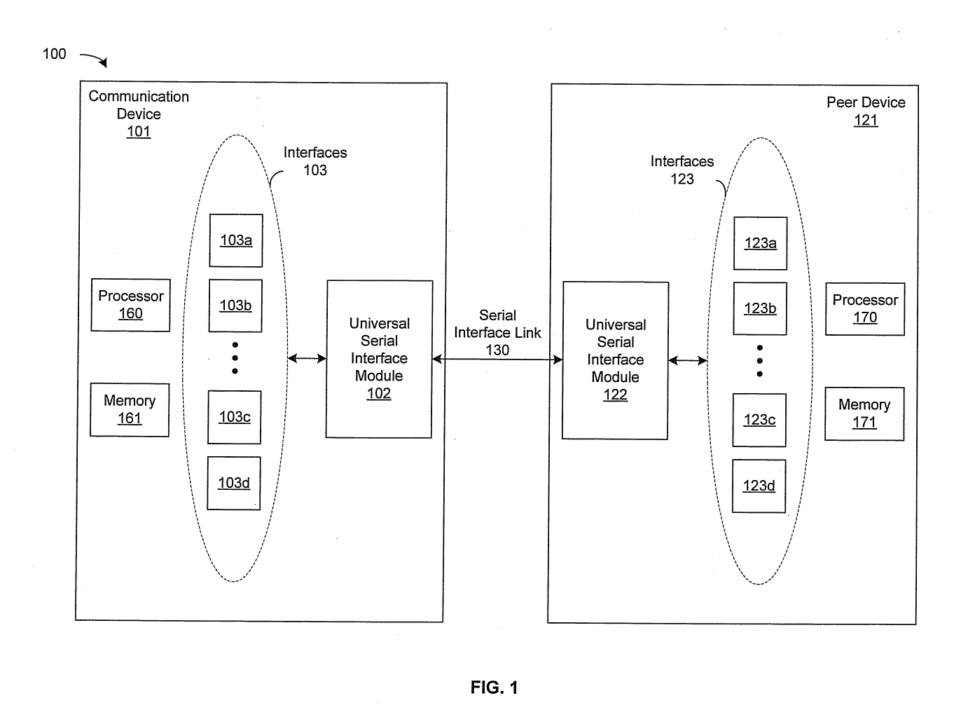

FIG. 1 is a block diagram illustrating an exemplary communication system that is operable to provide a universal serial interface, in accordance with an embodiment of the invention. Referring to FIG. 1, there is shown a communication system 100. The communication system 100 may comprise a communication device 101 and a peer device 121. The communication device 101 and the peer device 121 may be communicatively coupled via a serial interface link 130 utilizing a serial interface protocol. The communication device 101 may comprise, for example, a PC, a laptop, a tablet PC, a PDA and/or a wireless device. The peer device 121 may comprise, for example, a TV set, a monitor, a PC, a laptop and/or a docking station.

The communication device 101 may comprise a processor 160, a memory 161, a universal serial interface module 102 and a plurality of interfaces 103, of which interfaces 103a-103d are illustrated.

The processor 160 may comprise suitable logic, circuitry, interfaces and/or code that may be operable to coordinate operation of various components of the communication device 101. The processor 160 may control communication of information and signals between components of the communication device 101. The processor 160 may execute code stored in the memory 161.

The memory 161 may comprise suitable logic, circuitry, interfaces and/or code that may be operable to store information such as executable instructions, data and/or database that may be utilized by the processor 160. The memory 161 may comprise, for example, DRAM, SRAM, flash memory, a hard drive or other magnetic storage, and/or any other suitable electronic data storage.

Each of the plurality of interfaces 103 such as the interface 103a may comprise suitable logic, circuitry and/or code that may be operable to provide physical interface based on an interface protocol. For example, the interface 103a may comprise a universal serial bus (USB) interface, a Firewire interface, a high definition multimedia interface (HDMI), a digital visual interface (DVI), a DisplayPort (DP) interface, an external serial advanced technology attachment (eSATA) interface, an Ethernet interface, an IEEE 1394 interface, a video graphics array (VGA) interface, a peripheral component interconnect express (PCI-E) interface, an AUX interface, a general purpose input/output (GPIO) interface, a card reader interface and/or a docking port interface.

The universal serial interface module 102 may comprise suitable logic, circuitry, interfaces and/or code that may be operable to receive a plurality of signals from the plurality of interfaces 103 associated with one or more interface protocols. The universal serial interface module 102 may be operable to generate a serial signal from the plurality of signals corresponding to the plurality of interfaces 103. The generated serial signal may be communicated by the universal serial interface module 102 to the universal serial interface module 122 in the peer device 121 via the serial interface link 130 utilizing the serial interface protocol. The universal serial interface 102 may also be operable to receive a serial signal from the universal serial interface 122 in the peer device 121 via the serial interface link 130 utilizing the serial interface protocol. The received serial signal may be utilized by the universal serial interface module 102 to generate a plurality of signals corresponding to the plurality of interfaces 103 associated with the one or more interface protocols.

The peer device 121 may comprise a processor 170, a memory 171, a universal serial interface module 122 and a plurality of interfaces 123, of which interfaces 123a-123d are illustrated.

The processor 170 may comprise suitable logic, circuitry, interfaces and/or code that may be operable to coordinate operation of various components of the peer device 121. The processor 170 may control communication of information and signals between components of the peer device 121. The processor 170 may execute code stored in the memory 171.

The memory 171 may comprise suitable logic, circuitry, interfaces and/or code that may be operable to store information such as executable instructions, data and/or database that may be utilized by the processor 170. The memory 171 may comprise, for example, DRAM, SRAM, flash memory, a hard drive or other magnetic storage, and/or any other suitable electronic data storage.

Each of the plurality of interfaces 123, such as the interface 123a, may comprise suitable logic, circuitry and/or code that may be operable to provide physical interface based on an interface protocol. For example, the interface 123a may comprise a USB interface, a Firewire interface, a HDMI interface, a DVI interface, a DP interface, an eSATA interface, an Ethernet interface, an IEEE 1394 interface, a VGA interface, a PCI-E interface, an AUX interface, a GPIO interface, a card reader interface and/or a docking port interface.

The universal serial interface module 122 may comprise suitable logic, circuitry, interfaces and/or code that may be operable to receive a plurality of signals from the plurality of interfaces 123 associated with one or more interface protocols. The universal serial interface module 122 may be operable to generate a serial signal from the plurality of signals corresponding to the plurality of interfaces 123. The generated serial signal may be communicated by the universal serial interface module 122 to the universal serial interface module 102 in the communication device 101 via the serial interface link 130 utilizing the serial interface protocol. The universal serial interface 122 may also be operable to receive a serial signal from the universal serial interface 102 in the communication device 101 via the serial interface link 130 utilizing the serial interface protocol. The received serial signal may be utilized by the universal serial interface module 122 to generate a plurality of signals corresponding to the plurality of interfaces 123 associated with the one or more interface protocols.

In operation, the universal serial interface module 102 in the communication device 101 may be operable to receive a first plurality of signals from the plurality of interfaces 103 associated with the one or more interface protocols. The universal serial interface module 102 may be operable to generate a first serial signal from the first plurality of signals corresponding to the plurality of interfaces 103. The generated first serial signal may be communicated by the universal serial interface module 102 to the universal serial interface module 122 in the peer device 121 via the serial interface link 130 utilizing the serial interface protocol. In this regard, the communicated first serial signal may be utilized by the universal serial interface module 122 in the peer device 121 to regenerate the first plurality of signals corresponding to the plurality of interfaces 123 associated with the one or more interface protocols.

The universal serial interface module 122 in the peer device 121 may be operable to receive a second plurality of signals from the plurality of interfaces 123 associated with one or more interface protocols. The universal serial interface module 122 may be operable to generate a second serial signal from the second plurality of signals corresponding to the plurality of interfaces 123. The generated second serial signal may be communicated by the universal serial interface module 122 to the universal serial interface module 102, in the communication device 101, via the serial interface link 130 utilizing the serial interface protocol. In this regard, the communicated second serial signal may be utilized by the universal serial interface module 102 in the communication device 101 to regenerate the second plurality of signals corresponding to the plurality of interfaces 103 associated with the one or more interface protocols.

In some instances, the serial interface link 130 may comprise an interface using a copper medium such as, for example, a passive copper cable. In other instances, the serial interface link 130 may comprise an interface using an optical cable such as, for example, an active optical cable.

In the exemplary embodiment of the invention illustrated in FIG. 1, although a single serial interface link 130 is shown, the invention is not so limited. More than one serial interface links may be illustrated without departing from the spirit and scope of various embodiments of the invention. One or more native interface links utilizing the one or more interface protocols may also be shown between the communication device 101 and the peer device 121 without departing from the spirit and scope of various embodiments of the invention.

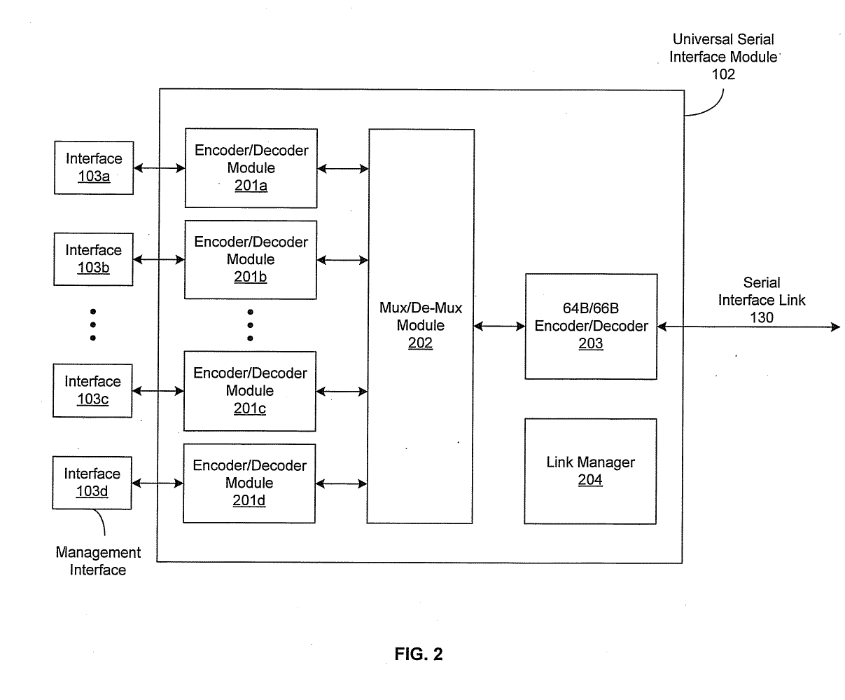

FIG. 2 is a block diagram illustrating an exemplary universal serial interface module that is operable to provide a universal serial interface in a communication device, in accordance with an embodiment of the invention. Referring to FIG. 2, there is shown the universal serial interface module 102, the plurality of interfaces 103a-103d and the serial interface link 130 described above with respect to FIG. 1. The universal serial interface module 102 may comprise a plurality of encoder/decoder modules 201a-201d, a Mux/De-Mux module 202, a 64B/66B encoder/decoder 203 and a link manager 204.

One of the interfaces 103a-103d such as the interface 103d may comprise a management interface associated with a management interface protocol. The management interface 103d may be an always present interface or channel with dedicated or allocated bandwidth. Signals on the management interface 103d may be utilized by the link manager 204 to configure the serial interface link 130.

Each of the plurality of encoder/decoder modules 201a-201d may comprise suitable logic, circuitry, interfaces and/or code that may be operable to perform encoding and/or decoding such as, for example, a 8B/10B encoding/decoding for each of the plurality of interfaces 103a-103d. For example, the encoder/decoder module 201a may encode a signal received from the interface 103a utilizing the 8B/10B encoding. The encoded signal may be transmitted to the Mux/De-Mux module 202. The encoder/decoder module 201a may decode a signal received from the Mux/De-Mux module 202 utilizing the 8B/10B decoding. The decoded signal may be transmitted to the interface 103a.

The Mux/De-Mux module 202 may comprise suitable logic, circuitry, interfaces and/or code that may be operable to perform multiplexing and/or de-multiplexing functions. For example, the Mux/De-Mux module 202 may be operable to time-division multiplex signals received from the plurality of encoder/decoder modules 201a-201d into a multiplexed serial signal, based on a configuration of the serial interface link 130. The Mux/De-Mux module 202 may format a signal or packet received from an encoder/decoder such as the encoder/decoder 201a based on a bandwidth requirement and a configured port ordering. The multiplexed serial signal may also comprise, for example, an error correction code (ECC) for reducing a bit error rate (BER) or packet error rate (PER). The multiplexed serial signal may be transmitted to the 64B/66B encoder/decoder 203. The Mux/De-Mux module 202 may be operable to time-division de-multiplex a serial signal received from the 64B/66B encoder/decoder 203 into a plurality of de-multiplexed signals for the plurality of encoder/decoder modules 201a-201d, for example.

The 64B/66B encoder/decoder 203 may comprise suitable logic, circuitry, interfaces and/or code that may be operable to perform a 64B/66B encoding and/or a 64B/66B decoding. For example, the 64B/66B encoder/decoder 203 may be operable to encode a serial signal received from the Mux/De-Mux module 202 utilizing the 64B/66B encoding. The encoded serial signal may be transmitted to the serial interface link 130. The 64B/66B encoder/decoder 203 may be operable to decode a serial signal received from the serial interface link 130 utilizing the 46B/66B decoding. The decoded serial signal may be transmitted to the Mux/De-Mux module 202.

The link manager 204 may comprise suitable logic, circuitry, interfaces and/or code that may be operable to manage the management interface 103d. The link manager 204 may be operable to configure the serial interface link 130 utilizing the management interface 103d. For example, the serial interface link 130 may be configured based on a bandwidth requirement associated with each of the plurality of interfaces 103a-103d and a link speed associated with the serial interface link 130. In this regard, each of the plurality of interfaces 103a-103d may be provided with a time-division multiplexing (TDM) slot and a needed bandwidth for transmitting a signal via the serial interface link 130. During the configuration of the serial interface link 130, the link manager 204 may utilize the management interface 103d to communicate information to a peer device such as the peer device 121. The communicated information may comprise, for example, a PHY type, an assigned port number, a bandwidth requirement and/or an actual bandwidth assignment associated with each of the plurality of interfaces 103a-103c. The link manager 204 may facilitate hot assignments and/or tearing down of an interface such as the interface 103a when the interface 103a becomes active and/or is being brought down.

In operation, the plurality of encoder/decoder modules 201a-201d in the universal serial interface module 102 of the communication device 101 may be operable to decode signals received from the plurality of interfaces 103a-103d respectively, utilizing, for example, the 8B/10B encoding. The plurality of interfaces 103a-103d may utilize one or more interface protocols. The Mux/De-Mux module 202 may be operable to time-division multiplex the encoded signals received from the plurality of encoder/decoder modules 201a-201d into a multiplexed serial signal, based on a configuration of the serial interface link 130. The serial interface link 130 may be configured by the link manager 204 utilizing the management interface 103d. The configuration of the serial interface link 130 may be based on, for example, a bandwidth requirement associated with each of the plurality of interfaces 103a-103d and a link speed associated with the serial interface link 130. The multiplexed serial signal may also comprise, for example, an error correction code (ECC) for reducing a bit error rate (BER). The 64B/66B encoder/decoder 203 may be operable to encode the multiplexed serial signal received from the Mux/De-Mux module 202 utilizing the 64B/66B encoding. The encoded serial signal may be transmitted to the serial interface link 130 for communicating to a peer device such as the peer device 121.

The 64B/66B encoder/decoder 203 may be operable to decode a serial signal received from the serial interface link 130 utilizing the 64B/66B decoding. The Mux/De-Mux module 202 may be operable to time-division de-multiplex the decoded serial signal received from the 64B/66B encoder/decoder 203 into a plurality of de-multiplexed signals. The plurality of encoder/decoder modules 201a-201d may be operable to decode the plurality of de-multiplexed signals respectively, utilizing, for example, the 8B/10B decoding. The decoded plurality of signals may be transmitted by the plurality of encoder/decoder 201a-201d to the plurality of interfaces 103a-103d, respectively.

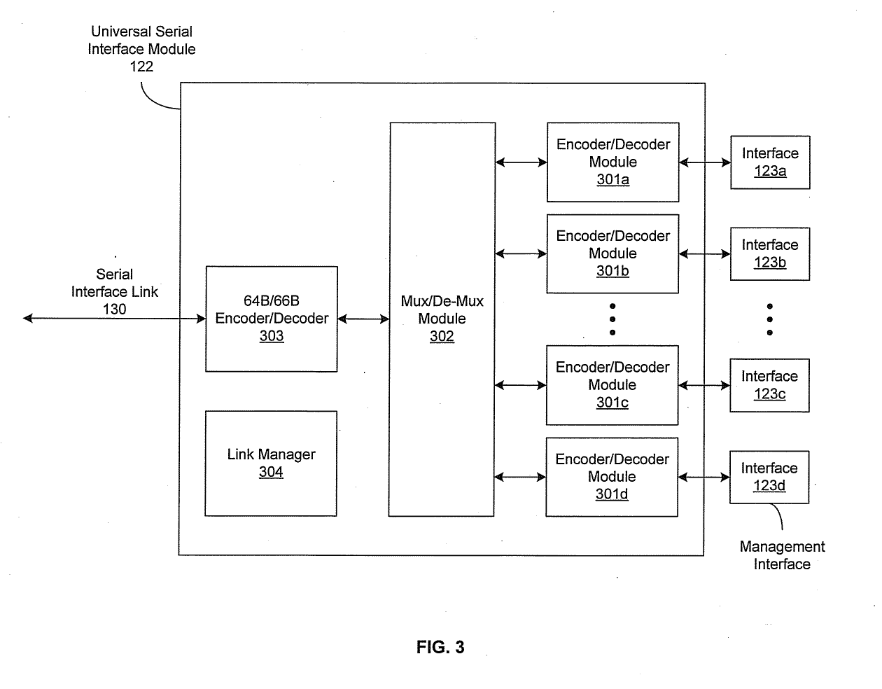

FIG. 3 is a block diagram illustrating an exemplary universal serial interface module that is operable to provide a universal serial interface in a peer device, in accordance with an embodiment of the invention. Referring to FIG. 3, there is shown the universal serial interface module 122, the plurality of interfaces 123a-123d and the serial interface link 130 described above with respect to FIG. 1. The universal serial interface module 122 may comprise a plurality of encoder/decoder modules 301a-301d, a Mux/De-Mux module 302, a 64B/66B encoder/decoder 303 and a link manager 304.

One of the interfaces 123a-123d such as the interface 123d may comprise a management interface associated with a management interface protocol. The management interface 123d may be an always present interface or channel with dedicated or allocated bandwidth. Signals on the management interface 123d may be utilized by the link manager 304 to configure the serial interface link 130.

Each of the plurality of encoder/decoder modules 301a-301d may comprise suitable logic, circuitry, interfaces and/or code that may be operable to perform encoding and/or decoding such as, for example, a 8B/10B encoding/decoding for each of the plurality of interfaces 123a-123d. For example, the encoder/decoder module 301a may encode a signal received from the interface 123a utilizing the 8B/10B encoding. The encoded signal may be transmitted to the Mux/De-Mux module 302. The encoder/decoder module 301a may decode a signal received from the Mux/De-Mux module 302 utilizing the 8B/10B decoding. The decoded signal may be transmitted to the interface 123a.

The Mux/De-Mux module 302 may comprise suitable logic, circuitry, interfaces and/or code that may be operable to perform multiplexing and/or de-multiplexing functions. For example, the Mux/De-Mux module 302 may be operable to time-division multiplex signals received from the plurality of encoder/decoder modules 301a-301d into a multiplexed serial signal, based on a configuration of the serial interface link 130. The Mux/De-Mux module 302 may format a signal or packet received from an encoder/decoder such as the encoder/decoder 301a based on a bandwidth requirement and a configured port ordering. The multiplexed serial signal may also comprise, for example, an error correction code (ECC) for reducing a bit error rate (BER) or packet error rate (PER). The multiplexed serial signal may be transmitted to the 64B/66B encoder/decoder 303. The Mux/De-Mux module 302 may be operable to time-division de-multiplex a serial signal received from the 64B/66B encoder/decoder 303 into a plurality of de-multiplexed signals for the plurality of encoder/decoder modules 301a-301d, for example.

The 64B/66B encoder/decoder 303 may comprise suitable logic, circuitry, interfaces and/or code that may be operable to perform a 64B/66B encoding and/or a 64B/66B decoding. For example, the 64B/66B encoder/decoder 303 may be operable to encode a serial signal received from the Mux/De-Mux module 302 utilizing the 64B/66B encoding. The encoded serial signal may be transmitted to the serial interface link 130. The 64B/66B encoder/decoder 303 may be operable to decode a serial signal received from the serial interface link 130 utilizing the 64B/66B decoding. The decoded serial signal may be transmitted to the Mux/De-Mux module 302.

The link manager 304 may comprise suitable, logic, circuitry, interfaces and/or code that may be operable to manage the management interface 123d. The link manager 304 may be operable to configure the serial interface link 130 utilizing the management interface 123d. For example, the serial interface link 130 may be configured based on a bandwidth requirement associated with each of plurality of interfaces 123a-123d and a link speed associated with the serial interface link 130. In this regard, each of the plurality of interfaces 123a-123d may be provided with a time-division multiplexing (TDM) slot and a needed bandwidth for transmitting a signal via the serial interface link 130. During the configuration of the serial interface link 130, the link manager 304 may utilize the management interface 123d to communicate information to a communication device such as the communication device 101. The communicated information may comprise, for example, a PHY type, an assigned port number, a bandwidth requirement and/or an actual bandwidth assignment associated with each of the plurality of interfaces 123a-123c. The link manager 304 may facilitate hot assignments and/or tearing down of an interface such as the interface 123a when the interface 123a becomes active and/or is being brought down.

In operation, the plurality of encoder/decoder modules 301a-301d in the universal serial interface module 122 of the peer device 121 may be operable to decode signals received from the plurality of interfaces 123a-123d respectively, utilizing, for example, the 8B/10B encoding. The plurality of interfaces 123a-123d may utilize one or more interface protocols. The Mux/De-Mux module 302 may be operable to time-division multiplex the encoded signals received from the plurality of encoder/decoder modules 301a-301d into a multiplexed serial signal, based on a configuration of the serial interface link 130. The serial interface link 130 may be configured by the link manager 304 utilizing the management interface 123d. The configuration of the serial interface link 130 may be based on, for example, a bandwidth requirement associated with each of the plurality of interfaces 123a-123d and a link speed associated with the serial interface link 130. The multiplexed serial signal may also comprise, for example, an error correction code (ECC) for reducing a bit error rate (BER). The 64B/66B encoder/decoder 303 may be operable to encode the multiplexed serial signal received from the Mux/De-Mux module 302 utilizing the 64B/66B encoding. The encoded serial, signal may be transmitted to the serial interface link 130 for communicating to a communication device such as the communication device 101.

The 64B/66B encoder/decoder 303 may be operable to decode a serial signal received from the serial interface link 130 utilizing the 64B/66B decoding. The Mux/De-Mux module 302 may be operable to time-division de-multiplex the decoded serial signal received from the 64B/66B encoder/decoder 303 into a plurality of de-multiplexed signals. The plurality of encoder/decoder modules 301a-301d may be operable to decode the plurality of de-multiplexed signals respectively, utilizing, for example, the 8B/10B decoding. The decoded plurality of signals may be transmitted by the plurality of encoder/decoder 301a-301d to the plurality of interfaces 123a-123d, respectively.

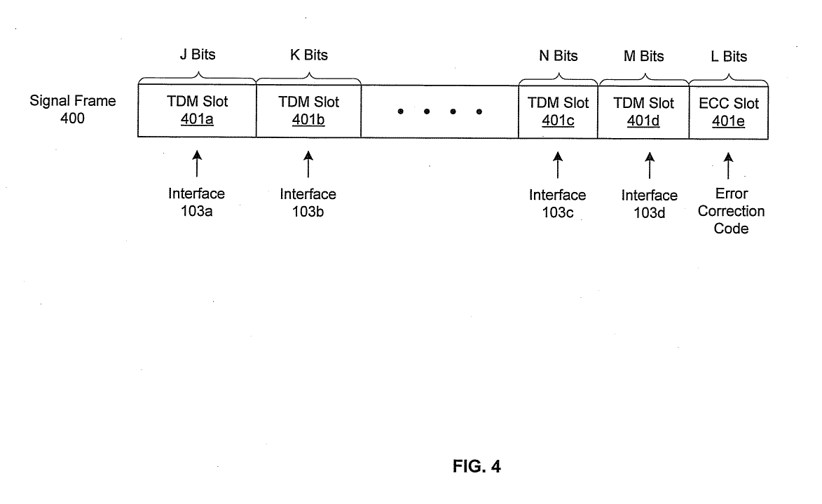

FIG. 4 is a block diagram illustrating an exemplary signal frame transported by a serial interface link, in accordance with an embodiment of the invention. Referring to FIG. 3, there is shown a signal frame 400 that may be transported by a universal interface link such as the serial interface link 130. The signal frame 400 may comprise a plurality of time slots, of which TDM slots 401a-401d and an ECC slot 401e are illustrated. In this regard, for example, the TDM slot 401a, which may be assigned to the interface 103a, may comprise J bits. The TDM slot 401b, which may be assigned to the interface 103b, may comprise K bits. The TDM slot 401c, which may be assigned to the interface 103c may comprise N bits. The TDM slot 401d, which may be assigned to the management interface 103d, may comprise M bits. The ECC slot 401e, which may correspond to the error correction code (ECC), may comprise L bits. Each of J, K, L, M, N is an integer that is greater than 0. For example, a signal associated with the interface 103a may be assigned with a bandwidth of 5 Gbits/sec at the TDM slot 401a for transporting by the serial interface link 130. Based on a 125 MHz clock operated in the universal serial interface module 102, the TDM slot 401a may comprise 40 bits, according to the equation of 40 bits×125 MHz=5 Gbits/sec. In this regard, the signal associated with the interface 103a may be provided with a guaranteed slot and a needed bandwidth. The L-bit error correction code (ECC) in the ECC slot 401e may be utilized to reduce a bit error rate (BER). For example, the bit error rate (BER) may be kept in the order of 1E-15.

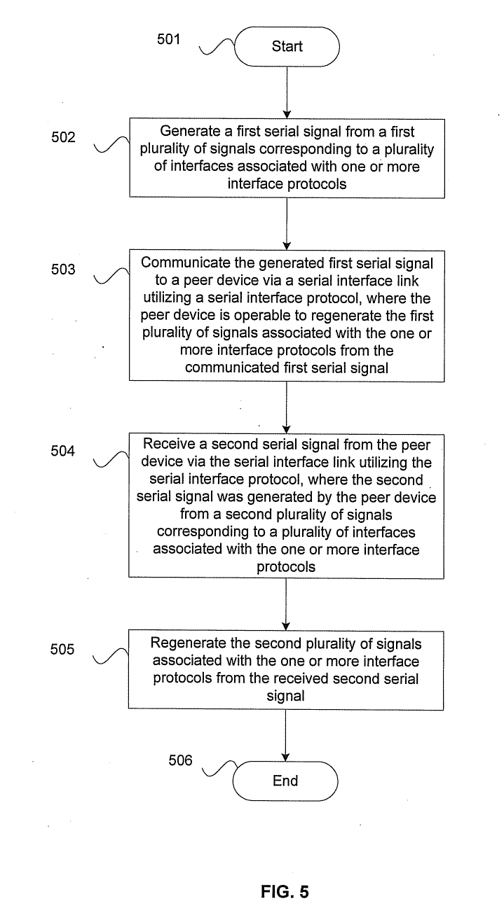

FIG. 5 is a flow chart illustrating exemplary steps for a universal serial interface, in accordance with an embodiment of the invention. Referring to FIG. 5, the exemplary steps start at step 501. In step 502, the universal serial interface module 102 in the communication device 101 may be operable to generate a first serial signal from a first plurality of signals corresponding to a plurality of interfaces 103a-103d associated with one or more interface protocols. In step 503, the universal serial interface module 102 may be operable to communicate the generated first serial signal to a peer device 121, via a serial interface link 130, utilizing a serial interface protocol. In this regard, the universal serial interface module 122 in the peer device 121 may be operable to regenerate the first plurality of signals associated with the one or more interface protocols from the communicated first serial signal. In step 504, the universal serial interface module 102 may be operable to receive a second serial signal from the peer device via the serial interface link 130 utilizing the serial interface protocol. In this regard, the second serial signal was generated by the universal serial interface module 122 in the peer device 121 from a second plurality of signals corresponding to a plurality of interfaces 123a-123d associated with the one or more interface protocols. In step 505, the universal serial interface module 102 may be operable to regenerate the second plurality of signals associated with the one or more interface protocols from the received second serial signal. The exemplary steps may proceed to the end step 506.

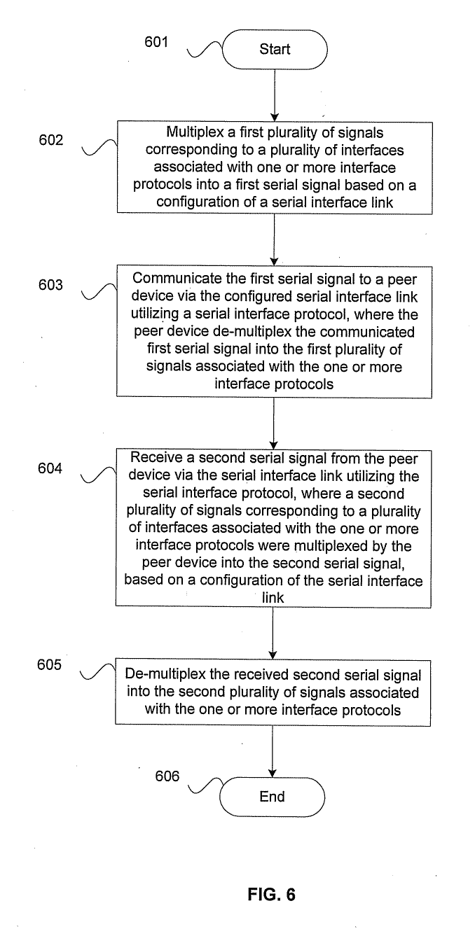

FIG. 6 is a flow chart illustrating exemplary steps for implementing a universal serial interface, in accordance with an embodiment of the invention. Referring to FIG. 6, the exemplary steps start at step 601. In step 602, the Mux/De-Mux module 202 in the universal serial interface module 102 of the communication device 101 may be operable to multiplex a first plurality of signals corresponding to a plurality of interfaces 103a-103d associated with one or more interface protocols into a first serial signal, based on a configuration of a serial interface link 130. The serial interface link 130 may be configured by the link manager 204 in the universal serial interface module 102 via the management interface 103d. In step 603, the universal serial interface module 102 may be operable to communicate the first serial signal to a peer device 121 via the configured serial interface link 130 utilizing a serial interface protocol. In this regard, the Mux/De-Mux module 302 in the universal serial interface module 122 of the peer device 121 may de-multiplex the communicated first serial signal into the first plurality of signals associated with the one or more interface protocols.

In step 604, the universal serial interface module 102 may be operable to receive a second serial signal from the peer device 121, via the serial interface link 130, utilizing the serial interface protocol. In this regard, a second plurality of signals corresponding to a plurality of interfaces 123a-123d associated with the one or more interface protocols were multiplexed by the Mux/De-Mux module 302 into the second serial signal, based on a configuration of the serial interface link 130. The serial interface link 130 may be configured by the link manager 304 in the universal serial interface module 122 via the management interface 123d. In step 605, the Mux/De-Mux module 202 may be operable to de-multiplex the received second serial signal into the second plurality of signals associated with the one or more interface protocols. The exemplary steps may proceed to the end step 606.

In various embodiments of the invention, a communication device 101 may comprise a serial interface such as a universal serial interface module 102. The communication device 101 may utilize the serial interface such as the universal serial interface module 102 to communicate with a peer device 121 via a serial interface link 130 utilizing a serial interface protocol. The universal serial interface module 102 in the communication device 101 may be operable to generate a first serial signal from a first plurality of signals associated with one or more interface protocols. The generated first serial signal may be communicated to the peer device 121, via the serial interface link 130, utilizing the serial interface protocol. In this regard, a universal serial interface module 122 in the peer device 121 may be operable to regenerate the first plurality of signals from the communicated first serial signal. The communication device 101 may be operable to receive a second serial signal from the peer device 121 via the serial interface link 130 utilizing the serial interface protocol. The second serial signal was generated by the universal serial interface module 122 in the peer device 121 from a second plurality of signals associated with the one or more interface protocols. In this regard, the universal serial interface module 102 in the communication device 101 may be operable to regenerate the second plurality of signals from the received second serial signal.

In an exemplary embodiment of the invention, one of the first plurality of signals may comprise a first management signal associated with a management interface protocol, and one of the second plurality of signals may comprise a second management signal associated with the management interface protocol. In such instances, a link manager 204 in the universal serial interface module 102 of the communication device 101 may be operable to configure the serial interface link 130 based on a bandwidth requirement associated with each of the first plurality of signals and a link speed associated with the serial interface link 130 utilizing the first management signal and/or the second management signal. The first plurality of signals may be multiplexed into the first serial signal by a Mux/De-Mux module 202 in the universal serial interface module 102 of the communication device 101. The first serial signal may then be communicated to the peer device 121 via the configured serial interface link 130. In this regard, a Mux/De-Mux module 302 in the universal serial interface module 122 of the peer device 121 may be operable to de-multiplex the communicated first serial signal into the first plurality of signals.

A link manager 304 in the universal serial interface module 122 of the peer device 121 may be operable to configure the serial interface link 130 based on a bandwidth requirement associated with each of the second plurality of signals and a link speed associated with the serial interface link 130 utilizing the first management signal and/or the second management signal. In this regard, the second plurality of signals may be multiplexed by the Mux/De-Mux module 302 in the universal serial interface module 122 of the peer device 121 into the second serial signals. The communication device 101 may be operable to receive the second serial signal from the peer device 121 via the configured serial interface link 130. The Mux/De-Mux module 202 in the universal serial interface module 102 of the communication device 101 may de-multiplex the received second serial signal into the second plurality of signals.

In some instances, the serial interface link 130 may comprise an interface using a copper medium, for example. In other instances, the serial interface link 130 may comprise an interface using an optical cable, for example. The serial interface protocol may comprise, for example, a 64B/66B coding and/or a bit error rate (BER) reduction utilizing an error correction code (ECC).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for a universal serial interface.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in a communication device comprising a serial interface, said communication device being operable to utilize said serial interface to communicate with a peer device via a serial interface link utilizing a serial interface protocol:
generating a first serial signal from a first plurality of signals that are associated with one or more interface protocols;
communicating said generated first serial signal to said peer device via said serial interface link utilizing said serial interface protocol, wherein said peer device is operable to regenerate said first plurality of signals from said communicated first serial signal;
receiving a second serial signal from said peer device via said serial interface link associated with said serial interface protocol, wherein said second serial signal was generated by said peer device from a second plurality of signals associated with said one or more interface protocols; and
regenerating said second plurality of signals from said received second serial signal.

2. The method according to claim 1, wherein:
one of said first plurality of signals comprises a first management signal associated with a management interface protocol; and
one of said second plurality of signals comprises a second management signal associated with said management interface protocol.

3. The method according to claim 2, comprising configuring said serial interface link based on a bandwidth requirement associated with each of said first plurality of signals and a link speed associated with said serial interface link utilizing said first management signal and/or said second management signal.

4. The method according to claim 3, comprising:
multiplexing said first plurality of signals into said first serial signal based on said configuration; and
communicating said first serial signal to said peer device via said configured serial interface link, wherein said peer device de-multiplexes said communicated first serial signal into said first plurality of signals.

5. The method according to claim 2, wherein said peer device configures said serial interface link based on a bandwidth requirement associated with each of said second plurality of signals and a link speed associated with said serial interface link utilizing said first management signal and/or said second management signal.

6. The method according to claim 5, comprising:
receiving said second serial signal from said peer device via said configured serial interface link, wherein said second plurality of signals were multiplexed by said peer device into said second serial signal based on said configuration; and
de-multiplexing said received second serial signal into said second plurality of signals.

7. The method according to claim 1, wherein said serial interface link comprises an interface using a copper medium.

8. The method according to claim 1, wherein said serial interface link comprises an interface using an optical cable.

9. The method according to claim 1, wherein said serial interface protocol comprises a 64B/66B coding.

10. The method according to claim 1, wherein said serial interface protocol comprises a bit error rate (BER) reduction utilizing an error correction code (ECC).

11. A system for communication, the system comprising:
one or more processors and/or circuits for use in a communication device, said communication device comprising a serial interface and being operable to utilizing said serial interface to communicate with a peer device via a serial interface link utilizing a serial interface protocol, said one or more processors and/or circuits being operable to:
generate a first serial signal from a first plurality of signals that are associated with one or more interface protocols;
communicate said generated first serial signal to said peer device via said serial interface link utilizing said serial interface protocol, wherein said peer device is operable to regenerate said first plurality of signals from said communicated first serial signal;
receive a second serial signal from said peer device via said serial interface link associated with said serial interface protocol, wherein said second serial signal was generated by said peer device from a second plurality of signals associated with said one or more interface protocols; and
regenerate said second plurality of signals from said received second serial signal.

12. The system according to claim 11, wherein:
one of said first plurality of signals comprises a first management signal associated with a management interface protocol; and
one of said second plurality of signals comprises a second management signal associated with said management interface protocol.

13. The system according to claim 12, wherein said one or more processors and/or circuits are operable to configure said serial interface link based on a bandwidth requirement associated with each of said first plurality of signals and a link speed associated with said serial interface link utilizing said first management signal and/or said second management signal.

14. The system according to claim 13, wherein said one or more processors and/or circuits are operable to:
multiplex said first plurality of signals into said first serial signal based on said configuration; and
communicate said first serial signal to said peer device via said configured serial interface link, and said peer device de-multiplexes said communicated first serial signal into said first plurality of signals.

15. The system according to claim 12, wherein said peer device configures said serial interface link based on a bandwidth requirement associated with each of said second plurality of signals and a link speed associated with said serial interface link utilizing said first management signal and/or said second management signal.

16. The system according to claim 15, wherein said one or more processors and/or circuits are operable to:
receive said second serial signal from said peer device via said configured serial interface link, and said second plurality of signals were multiplexed by said peer device into said second serial signal based on said configuration; and
de-multiplex said received second serial signal into said second plurality of signals.

17. The system according to claim 11, wherein said serial interface link comprises an interface using a copper medium.

18. The system according to claim 11, wherein said serial interface link comprises an interface using an optical cable.

19. The system according to claim 11, wherein said serial interface protocol comprises a 64B/66B coding.

20. The system according to claim 11, wherein said serial interface protocol comprises a bit error rate (BER) reduction utilizing an error correction code (ECC).
